(19) United States
(12) Patent Application Publication
(10) Pub. No.: US 2020/0175421 A1
(43) Pub. Date: Jun. 4, 2020

(54) MACHINE LEARNING METHODS FOR DETECTION OF FRAUD-RELATED EVENTS

(71) Applicant: SAP SE, Walldorf (DE)

(72) Inventor: Keguo Zhou, Shanghai (CN)

(21) Appl. No.: 16/205,116

(22) Filed: Nov. 29, 2018

(51) Int. Cl. G06N 20/10; G06Q 20/40; G06N 7/00; G06K 9/62

(52) U.S. Cl. CPC G06N 20/10; G06K 9/6286; G06N 7/00; G06Q 20/4016

(57) ABSTRACT

Machine learning systems and methods for training one or more computing models. The method may comprise using historical event data associated with fraud-related events to determine whether data associated with an event provides an indication that the event is fraudulent. The events may be inputted to the computing model classified as fraudulent or non-fraudulent based on event-related parameters processed by the computing model according to the training. The training may continue by iteratively adjusting parameters w and b, respectively associated with weights and biases for event-related input data. Values associated with the parameters w and b may be updated to adjust preferences given to one or more event-related parameters and to influence the computing model toward generating an outcome that is more accurate.

### TECHNICAL FIELD

The disclosed subject matter generally relates to fraud prevention technology and, more particularly, to the optimization of fraud prevention or fraud detection methods using machine learning technology.

### BACKGROUND

To help identify fraudulent events or attempts, event or transaction data may be gathered and analyzed for indicators of nefarious activity. Computerized models are available that rely on a history of past events to determine whether a new event fits a suspected pattern. Most of these models are trained based on data that provides indications of what a normal activity is like. If, based on the training, event-related data fits the normal pattern, no fraud is detected. Otherwise, a fraud indication may be provided by the machine learning technology.

Models that are trained mainly based on normal (i.e., non-fraudulent) activity indicators may be imbalanced and include inaccuracies. This is because such models classify events or transactions mainly based on patterns recognized across a large set of transactions that have been classified as associated with normal activity. Unfortunately, such models may misclassify some fraudulent events that have both indicators of fraud and normal activity as non-fraudulent, due to the lack of sufficient training for patterns that indicate fraud.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, machine learning systems and methods for training a computing model are provided. The method may comprise using historical event data associated with fraud-related events to determine whether data associated with an event provides an indication that the event is fraudulent or non-fraudulent. The events may be inputted to the computing model classified as fraudulent or non-fraudulent based on event-related parameters processed by the computing model according to the training. The training may continue by iteratively adjusting parameters w and b, respectively associated with weights and biases for event-related input data. Values associated with the parameters w and b may be updated to adjust preferences given to one or more event-related parameters and to influence the computing model toward generating an outcome that is more accurate. The computing model may be optimized consistent with an objective for making the computing model more balanced. Such objective may be accomplished by at least attempting to cause a reduction or minimization in penalties calculated based on determining whether the computing model wrongfully categorized the events inputted to the computing model.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates example training and operating environments, in accordance with one or more embodiments, wherein an event may be classified as fraudulent or non-fraudulent by a machine learning model.

FIG. 2 is an example flow diagram of a method of optimizing a machine learning model, in accordance with one embodiment.

FIG. 3 is a block diagram of a computing system 1000 consistent with one or more embodiments.

Where practical, the same or similar reference numbers denote the same or similar or equivalent structures, features, aspects, or elements, in accordance with one or more embodiments.

### DETAILED DESCRIPTION OF EXAMPLE IMPLEMENTATIONS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

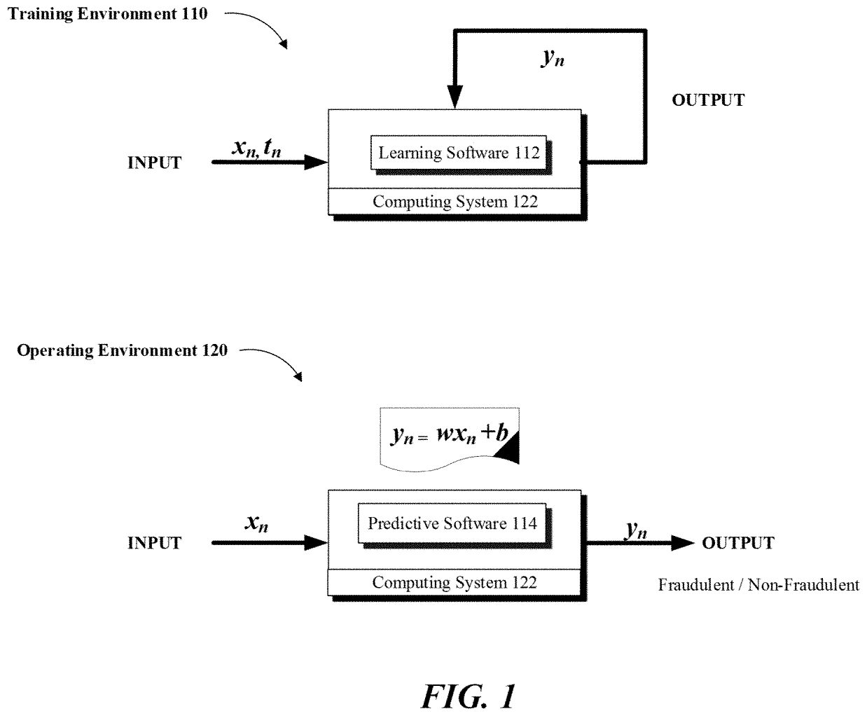

Referring to FIG. 1, example training environment 110 and operating environment 120 are illustrated. As shown, a computing system 122 and training data may be used to train learning software 112. Computing system 122 may be a general purpose computer, for example, or any other suitable computing or processing platform. Learning software 112 may be a machine learning or self-learning software that receives event-related input data. In the training phase, an input event may be known as belonging to a certain category (e.g., fraudulent or non-fraudulent) such that the corresponding input data may be tagged or labeled as such.

In accordance with one or more embodiments, learning software 112 may process the input data associated with a target event, without paying attention to the labels (i.e., blindly), and may categorize the target event according to an initial set of weights (w) and biases (b) associated with the input data. When the output is generated (i.e., when the event is classified as fraudulent or non-fraudulent by learning software 112), the result may be checked against the associated labels to determine how accurately learning software 112 is classifying the events.

In the initial stages of the learning phase, the categorization may be based on randomly assigned weights and biases, and therefore highly inaccurate. However, learning software 112 may be trained based on certain incentives or disincentives (e.g., a calculated loss function) to adjust the manner in which the provided input is classified. The adjustment may be implemented by way of adjusting weights and biases associated with the input data. Through multiple iterations and adjustments, the internal state of learning software 112 may be continually updated to a point where a satisfactory predictive state is reached (i.e., when learning software 112 starts to more accurately classify the inputted events at or beyond an acceptable threshold).

In the operating environment 120, predictive software 114 may be utilized to process event data provided as input. It is noteworthy that, in the operating phase, input data is unlabeled because the fraudulent nature of events being processed is unknown to the model. Software 114 may generate an output that classifies a target event as, for example, belonging to the fraudulent category, based on fitting the corresponding event data into the fraudulent class according to the training data received during the training phase. In accordance with example embodiments, predictive software 114 may be a trained version of learning software 112 and may be executed over computing system 122 or another suitable computing system or computing infrastructure.

Accordingly, to implement an effective fraud detection model, event data may be analyzed for certain features that indicate fraud. Based on the analysis of such features, the transaction may be categorized as either fraudulent or non-fraudulent. Depending on implementation, in case of a financial event or transaction, the analyzed features may include a transaction's underlying subject matter (e.g., the amount of money being transacted) and one or more account features associated with the parties or accounts involved in the transaction. Accordingly, the probability or likelihood of whether a transaction is fraudulent or not may be calculated based on the transaction amount (e.g., the financial value involved), the region or profile from which the transfer was initiated, or the region or profile to which the transfer is directed.

An example scenario is provided herein with reference to detecting fraud-related events involving financial transactions, without limiting the scope of this disclosure to such particular example. In such example scenario, features from raw transaction data may be provided as input to train a model with labeled data. The features may be included in fields that are associated with the amount of a transaction, region in which the transaction was initiated or received, or the related account profiles.

In one implementation, a profile may be defined for a transaction or account involved in the transaction. The profile may include features such as prior fraud history, registration time, most frequently used transfer out region (i.e., region where the transaction was initiated), most frequently used transfer in region (i.e., region where the transaction was received), and a list or matrix of frequency of transactions in different time durations, or lists or matrices to define the amount of transactions in different durations.

Examples of lists or matrices that may be utilized in one or more embodiments are provided below.

TABLE 1
Frequency of Transactions in Different Time Durations

| Duration | Frequency of Transactions |
|---|---|
| Recent 1 Week | 5 times |
| Recent 2 Week - | 0 times |
| Recent 1 Week | |
| Recent 3 Week - | 0 times |
| Recent 2 Week | |
| Recent 4 Week - | 1 times |
| Recent 3 Week | |

TABLE 2
Mean Amount Transferred

| Duration | Mean Amount Transferred In (*1000) |
|---|---|
| Recent 1 Week | 0 |
| Recent 2 Week - | 0 |
| Recent 1 Week | |
| Recent 3 Week - | 0 |
| Recent 2 Week | |
| Recent 4 Week - | 5 |
| Recent 3 Week | |

TABLE 3
Variance of Transferred In

| Duration | Variance Transferred In (*1000) |
|---|---|
| Recent 1 Week | 0 |
| Recent 2 Week - | 0 |
| Recent 1 Week | |
| Recent 3 Week - | 0 |
| Recent 2 Week | |
| Recent 4 Week - | 0 |
| Recent 3 Week | |

TABLE 4
Mean Amount Transferred Out

| Duration | Mean Amount Transferred Out (*1000) |
|---|---|
| Recent 1 Week | 50 |
| Recent 2 Week - | 0.5 |
| Recent 1 Week | |
| Recent 3 Week - | 1 |
| Recent 2 Week | |
| Recent 4 Week - | 0 |
| Recent 3 Week | |

TABLE 5
Variance of Transferred Out

| Duration | Variance of Amount Transferred Out (*1000) |
|---|---|
| Recent 1 Week | 53.666 |
| Recent 2 Week - | 0 |
| Recent 1 Week | |
| Recent 3 Week - | 0 |
| Recent 2 Week | |
| Recent 4 Week - | 0 |
| Recent 3 Week | |

According to the above information, a profile for an account may be determined. The account profile information may be reviewed and utilized to determine an account owner's transfer patterns. Newly collected information for the account may be compared to the account profile information for activities or events involving incoming and outgoing transactions to determine whether a target transaction meets certain thresholds established based on the account's historical profile. In other words, historical account profile data may be utilized to detect any anomaly in account activity or outlier transactions.

By way of example, Table 6 below provides sample transaction data associated with an example transaction or activity. In this example scenario, the transaction amount may be $90,000 amount of transaction, transfer in region may be Shanghai, and transfer out region may be Beijing.

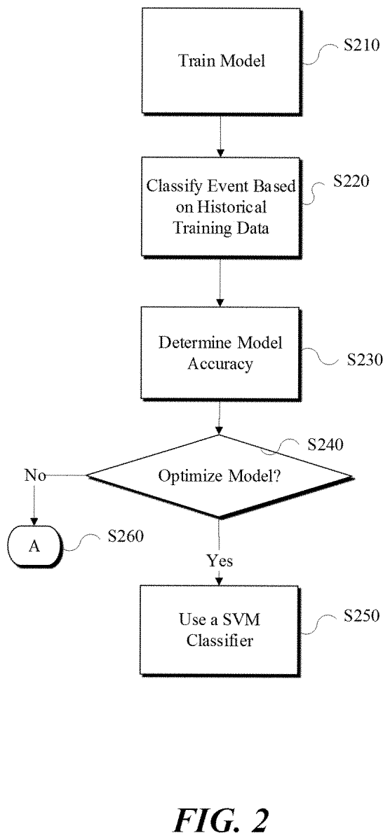

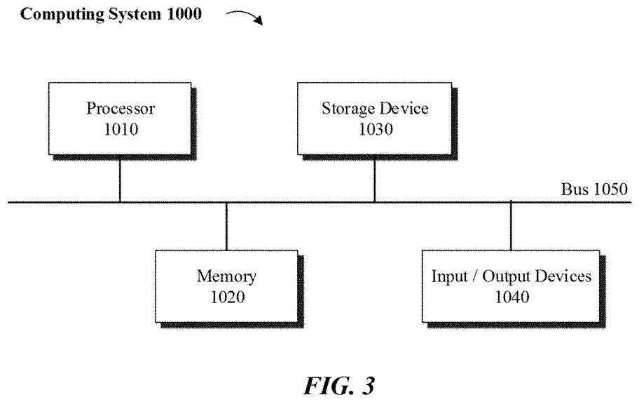

TABLE 6

| | |
|---|---|
| Prior fraud history | No |
| Time of Transaction | 2017 May 12 |
| Most frequently used transfer out region | Chengdu |
| Most frequently used transfer in region | Shanghai |
| Frequency of transactions | FIG. 1 |
| Mean amount transferred in | FIG. 2 |
| Variance of amount transferred in | FIG. 3 |
| Mean amount transferred out | FIG. 4 |
| Variance of amounts transferred out | FIG. 5 |

Comparing the information associated with the above transaction with the account's profile, outlier transaction features may be detected. For example, the transfer out region for the above transaction is not the same as the commonly used transfer out region for the account. Further, the amount of the transaction is a substantially larger than the mean transfer out amount (i.e., the mean out going transaction amount) according to the account's profile. Even further, the transfer out variance and frequency of transactions increase rapidly in the recent week. Accordingly, due to the anomalies detected, the example transaction of Table 6 is likely a fraudulent transaction.

In one or more implementations, the anomalies in transaction data may be detected by way of a machine learning approach, which may be used to advantageously train a computerized learning model to look at hundreds of thousands of transaction to build an account profile and also monitor hundreds of thousands of transactions in real-time to detect anomalies according to improved methodologies disclosed herein.

Referring to FIG. 2, in one implementation, a logistic statistical model may be used to apply a binary dependent variable in a binary classification problem to help build and train a logistic classification model (S210), for example, according to the following formulas:

yₙ=wxₙ+b (1.1)

L=Σₙ₌₁^{N}log(1+e^{-y}^{ₙ}^{t}^{ₙ})+λ∥w∥²

where λ denotes a coefficient of the regularization term for w.

Formula 1.1 may be used to calculate an output value y for one or more input data x, and to help further classify data that, as applied to the model, satisfies a condition (e.g., if y>0), suggesting a corresponding transaction belongs to a fraudulent (e.g., positive) class. If data as applied to the model does not satisfy the respective condition (e.g., if y<0), the transaction may be recognized as belonging to a non-fraudulent (e.g., negative) class, for example. To summarize, xₙ may denote a feature or attribute associated with an event, and yₙ may represent a hypothetical prediction of xₙ. If a certain condition is met (e.g., yₙ>0), transaction data (xₙ) may be deemed as fraudulent, for example, based on historical training data previously fed to the model (S220).

In accordance with one or more aspects, w and b, may be parameters that respectively define weights and biases associated with different event features. For example, event data inputted to a predictive model may include some features that may be represented by example transaction vectors x₁ and x₂:
x₁=[1,1,1,0.2,0.2,0.2]
x₂=[0.1,0.1,0.1,1,1,1]

A transaction vector may be a set of values associated with parameters that define a transaction. During the training phase, it may be known that the first transaction data x₁ refers to a fraudulent event which is labeled as t₁=1, and the second transaction data x₂ refers to a non-fraudulent event, which is labeled as t₂=−1. When the above transaction data is fed to the model as input, during the training phase, initially w and b may be stochastic or randomly generated numbers. For example, w may be [0.1,0.1,0.1,0.1,0.1,0.1] and b may be [0,0,0,0,0,0]. In this example, the y function calculated based on said example values may yield y₁=0.36 which is greater than 0 and y₂=0.33 which is also greater than 0.Thus, first and second transactions may both be deemed fraudulent in the training stage.

To determine the model's accuracy (S230), tₙ values noted above (i.e., t₁ and t₂) may be compared with the actual classification results. In the above example, it may be determined that the training model misclassified the second transaction as fraudulent, because label t₂ is indicated as negative, while the generated result y₂ is positive. This misclassification may be reflected in a loss function with the caveat that when an event is classified in the wrong class, the loss function is more heavily influenced in comparison with a scenario in which an event is classified into the correct class. This is because correct classification increases the loss value by a small amount and incorrect classification increases the loss value by a relatively larger amount in a scenario in which the model is mainly trained based on historical data associated with non-fraudulent transactions.

In some aspects, the model constructed according to the above implementation may be optimized (S240). In one embodiments, Formula 1.2 may be used to calculate a loss function that may be used to measure the model's performance (i.e., how accurately the model is classifying or detecting fraudulent events). In one example embodiment, the bigger the loss value is, the worse the prediction model performs, in terms of being able to predict the correct outcome. To help improve performance, in one or more embodiments, a stochastic gradient descend (SGD) method may be advantageously utilized, for example, to update parameters w and b. Accordingly, SGD may be used as an iterative method for optimizing a differentiable objective function based on a stochastic approximation of gradient descent optimization.

In one or more embodiments, a loss function according to Formula 1.3 may be advantageously used to adopt a cross entropy loss function to calculate a loss value that represent the accuracy of the classification by the model.

L=−Σₙ₌₁^{N}[tₙlog(h_{w}(x))+(1−tₙ(log(1−h_{w}(x))] (1.3)
h_{w}(x) denoting the hypothetical prediction of x, and
tₙ denoting the label of the sample xₙ.

In one or more implementations, a cost matrix may be advantageously utilized according to Formula 1.4 and Table 1 provided below, where α and β values are penalties applied when the model classifies an event in the wrong class, for example.

L=−Σₙ₌₁^{N}[αₙlog(h_{w}(x))+β(1−tₙ(log(1−h_{w}(x))] (1.4)

TABLE 1

True Class

| | | Positive | Negative |
|---|---|---|---|
| Predict Class | Positive | 1 | β |
| | Negative | α | 1 |

In some implementations, certain restrictions (e.g., >β) may be imposed, so that the model may be configured to give additional weight to data that indicates a fraudulent activity to help resolve the imbalance discussed earlier herein with respect to overreliance on non-fraudulent historical data for classifying a target event. Accordingly, data that indicates fraudulent activity may be more influential in the outcome of the model than data that indicates non-fraudulent activity. This implementation may help optimize the model to more accurately distinguish fraudulent transactions by considering a measured difference between the two classifications (i.e., fraudulent vs. non-fraudulent).

Depending on implementation, machine learning features such as support vector machines (SVMs) may be advantageously employed to account for data used for classification and regression analysis (S250). SVMs may be implemented as supervised learning models with associated learning algorithms that analyze data used for classification and regression analysis. Given a set of training examples marked as belonging to the fraudulent or non-fraudulent categories, an SVM training algorithm may build a model configured to assign new examples to one category or the other, making it a non-probabilistic binary linear classifier, for example.

An SVM model may be a representation of points in space, mapped so that the examples of the separate categories are divided by a clear gap that is as wide as possible. New examples values may be mapped into the same space as predicted to belong to a category based on which side of the gap the examples values fall. In addition to performing linear classification, SVMs may efficiently perform a non-linear classification using a kernel method, as provide in further detail herein, by implicitly mapping inputs to the model into high-dimensional feature spaces. In embodiments where input data is not labeled, supervised learning may not be possible, and an unsupervised learning approach may be utilized instead. In the unsupervised approach, natural clustering of the data to groups may be found during training, and during predictive use, input data may be mapped to the formed groups.

In accordance with some variations, an SVM may be used to train a model by assigning new examples that fit into the different classifications (e.g., fraudulent vs. non-fraudulent) to help improve the model towards a non-probabilistic binary linear classifier. A kernel method may be used, in certain applications, to train and test an SVM model so that a loss function that may cause an imbalance in the classification is not needed. As such, in one embodiment, instead of determining the accuracy of a model, using a loss function, the SVM may be treated as a max margin problem according to Formula 1.5 or Formula 1.6, which further simplify the model using a Lagrange multiplier towards a solvable quadratic programming problem.

$$arg {min}_{w , b} \frac{1}{2} {\vert \vert w \vert \vert}^{2} s . t . ∀ n , {t}_{n} ( {w}^{T} φ ( {x}_{n} ) + b ) \geq 1 \qquad Formula 1.5$$

wherein parameters w and b minimize the term ∥w∥², on condition that the inequality persist for any n.
Φ(xₙ) denotes a function that project xₙ into some lower dimensional space.

$${max}_{{a}_{i}} {\sum }_{n = 1}^{N} {a}_{n} - \frac{1}{2} {\sum }_{n = 1}^{N} {\sum }_{m = 1}^{M} {a}_{n} {a}_{m} {t}_{n} {t}_{m} {φ ( {x}_{n} )}^{T} φ ( {x}_{m} ) \\ s . t . {a}_{i} \geq 0 , i = 1 , 2 … N ; {\sum }_{n = 1}^{M} {a}_{n} {t}_{n} = 0 \\ \{ {a}_{1} , {a}_{2} … {a}_{n} \} are Lagrange multipliers , which replace w and b in a different form . \qquad Formula 1.6$$

To optimize the fraud detection methodology disclosed herein, in one or more embodiments, Lagrange multipliers may be utilized to find the local maxima and minima of a function that reduces the probability for the wrong classification to equality constraints (i.e., subject to the condition that one or more equations are satisfied by the chosen values of the variables). Using this method, the optimization may be advantageously performed without explicit parameterization in terms of the constraints.

Formula 1.5 represents the mathematical expression for a max margin problem in which samples in a training set may be restricted to be classified correctly in a remarkable way (e.g., restricting tₙyₙ>1). Further, parameters w and b may be assigned the minimum value that satisfies the restriction, such that even though there may be many w and b values that may satisfy the restriction, w and b values are selected that are the smallest values, for example.

In one or more embodiments, using the above training formulas to train the model may provide for a more accurate model. An SVM may be a linear classifier and sometimes the classification boundary may not be linearly definable (e.g., the boundary may be more accurately defined by a curve). Further, Formula 1.5 may be difficult to solve because it is not a quadratic math problem. As such, in accordance with one or more embodiments, to enable the SVM to solve a nonlinear classification problem, model data may be mapped to a higher dimension (e.g., from 2D to 3D) according to Formula 1.6 which may be represented by a mathematical derivation of formula 1.5.

An example implementation utilizing Formula 1.6 may be more efficient because a mathematical derivation of Formula 1.5 would have a defined solution. Further, by projecting input features to a higher dimension, a line in higher dimension may be projected to lower dimension as curves. Calculating in higher dimensions may be time-consuming and also difficult. In one or more aspects, one or more kernel methods may be adopted to help simplify calculations. Using a kernel method, for example, a dot product may be completed in a lower dimension and the calculated results may be mapped to a higher dimension. The following example kernel methods may be used, in accordance with one or more embodiments:

$$\begin{matrix}Linear \text{:} & K ( {x}_{i} , {x}_{j} ) = {x}_{i}^{T} {x}_{j} \\ Polynomial \text{:} & K ( {x}_{i} , {x}_{j} ) = {( {ax}_{i}^{T} {x}_{j} + b )}^{d} \\ Gauss \text{:} & K ( {x}_{i} , {x}_{j} ) = {e}^{- \frac{{‖ {x}_{i} - {x}_{j} ‖}^{2}}{2 {σ}^{2}}}\end{matrix}$$

In one example, a Gauss kernel may be used in one implementation to map the original data to an infinite dimension. Because Gauss kernel may be used to solve binary classifications, in one or more embodiments, a Gauss kernel may be used to train the SVM model. Accordingly, different machine learning methods are provided to help detect fraudulent transactions or attempts, particularly in scenarios where historical transaction data for training a fraud detection model is imbalanced.

Referring to FIG. 3, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 3, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

A portion of the disclosure of this patent document may contain material, which is subject to copyright protection. The owner has no objection to facsimile reproduction by any one of the patent document or the patent disclosure, as it appears in the Patent and Trademark Office patent file or records, but reserves all copyrights whatsoever. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

What is claimed is:

1. A computer-implemented method for detecting fraud-related events, the method comprising:
training a computing model, during a training phase, using historical event data associated with fraud-related events, wherein the model learns patterns to determine whether data associated with an event provides an indication that the event is fraudulent or non-fraudulent,
events inputted to the computing model being classified as fraudulent or non-fraudulent, during an operational phase, based on event-related parameters being processed by the computing model according to the training;
continue training the computing model by iteratively adjusting parameters w and b, respectively associated with weights and biases for event-related input data;
adjusting values associated with the parameters w and b to adjust preferences given to one or more event-related parameters and to influence the computing model toward generating an outcome that is more accurate; and
optimizing the computing model consistent with an objective for making the computing model more balanced, the objective being accomplished by at least attempting to cause a reduction or minimization in penalties calculated based on determining whether the computing model wrongfully categorized the events inputted to the computing model.

2. The computer-implemented method of claim 1, wherein the computing model is trained according to the following formulas to determine a loss function L and generate an output yₙ:
yₙ=wxₙ+b (1.1)
L=Σₙ₌₁^{N}log(1+e^{-y}^{ₙ}^{t}^{ₙ})+λ∥w∥², (1.2)
wherein
λ denotes a coefficient of regularization term for w, and
xₙ denotes a feature or attribute associated with an event inputted to the computing model, and yₙ represents a hypothetical prediction of xₙ, such that when a first condition is met, xₙ is categorized as fraudulent.

3. The computer-implemented method of claim 1, wherein a stochastic gradient descend (SGD) method is utilized to adjust the values associated with the parameters w and b.

4. The computer-implemented method of claim 1, wherein a loss function according to Formula 1.3 is adopted to optimize the computing model based on determining a cross entropy loss function for calculating a loss value for the computing model,
L=−Σₙ₌₁^{N}[tₙlog(h_{w}(x))+(1−tₙ(log(1−h_{w}(x))] (1.3)
h_{w}(x) denoting a hypothetical prediction of x, and
tₙ denoting a label of sample xₙ.

5. The computer-implemented method of claim 1, wherein a cost matrix according to Formula 1.4 is adopted to further optimize the computing model, where α and β values are penalties applied when the computing model classifies an event in the wrong class,
L=−Σₙ₌₁^{N}[αtₙlog(h_{w}(x))+β(1−tₙ)log(1−h_{w}(x))]. (1.4)

6. The computer-implemented method of claim 5, wherein further optimization comprises restricting the computing model to meet condition α>β, in the training phase, to configure the computing model to give additional weight to data that indicates a fraudulent activity.

7. The computer-implemented method of claim 1, wherein support vector machines (SVMs) are employed to implement supervised learning models with associated learning algorithms that analyze data used for classification and regression analysis to optimize the computing model.

8. The computer-implemented method of claim 7, wherein a set of training examples marked as belonging to fraudulent or non-fraudulent categories and the SVMs are used to train the computing model as a non-probabilistic binary linear classifier.

9. The computer-implemented method of claim 8, wherein the SVMs perform a non-linear classification using a kernel method.

10. The computer-implemented method of claim 9, wherein the SVMs are treated as max margin problems according to Formula 1.5 or Formula 1.6, to further simplify the computing model using a Lagrange multiplier towards a solvable quadratic programming problem,
$$arg {min}_{w , b} \frac{1}{2} {\vert \vert w \vert \vert}^{2} s . t . ∀ n , {t}_{n} ( {w}^{T} φ ( {x}_{n} ) + b ) \geq 1 \qquad Formula 1.5$$
wherein parameters w and b minimize the term ∥w∥², on condition that the inequality persist for any n.
Φ(xₙ) denotes a function that project xₙ into some lower dimensional space.
$${max}_{{a}_{i}} {\sum }_{n = 1}^{N} {a}_{n} - \frac{1}{2} {\sum }_{n = 1}^{N} {\sum }_{m = 1}^{M} {a}_{n} {a}_{m} {t}_{n} {t}_{m} {φ ( {x}_{n} )}^{T} φ ( {x}_{m} ) \\ s . t . {a}_{i} \geq 0 , i = 1 , 2 … N ; {\sum }_{n = 1}^{M} {a}_{n} {t}_{n} = 0 \qquad Formula 1.6$$
{a₁, a₂ . . . aₙ} are Lagrange multipliers, which replace w and b.

11. A computer-implemented system comprising:
at least one programmable processor; and
a non-transitory machine-readable medium storing instructions that, when executed by the at least one programmable processor, cause the at least one programmable processor to perform operations comprising:
training a computing model, during a training phase, using historical event data associated with fraud-related events, wherein the model learns patterns to determine whether data associated with an event provides an indication that the event is fraudulent or non-fraudulent,
events inputted to the computing model being classified as fraudulent or non-fraudulent, during an operational phase, based on event-related parameters being processed by the computing model according to the training;
continue training the computing model by iteratively adjusting parameters w and b, respectively associated with weights and biases for event-related input data;
adjusting values associated with the parameters w and b to adjust preferences given to one or more event-related parameters and to influence the computing model toward generating an outcome that is more accurate; and
optimizing the computing model consistent with an objective for making the computing model more balanced, the objective being accomplished by at least attempting to cause a reduction or minimization in penalties calculated based on determining whether the computing model wrongfully categorized the events inputted to the computing model.

12. The computer-implemented system of claim 11, wherein the computing model is trained according to the following formulas to determine a loss function L and generate an output yₙ:
yₙ=wxₙ+b (1.1)
L=Σₙ₌₁^{N}log(1+e^{-y}^{ₙ}^{t}^{ₙ})+λ∥w∥², (1.2)
wherein
λ denotes a coefficient of regularization term for w, and
xₙ denotes a feature or attribute associated with an event inputted to the computing model, and yₙ represents a hypothetical prediction of xₙ, such that when a first condition is met, xₙ is categorized as fraudulent.

13. The computer-implemented system of claim 11, wherein a stochastic gradient descend (SGD) method is utilized to adjust the values associated with the parameters w and b.

14. The computer-implemented system of claim 11, wherein a loss function is adopted to optimize the computing model based on determining a cross entropy loss function for calculating a loss value for the computing model.

15. The computer-implemented system of claim 11, wherein a cost matrix is adopted to further optimize the computing model according to penalties applied when the computing model classifies an event in the wrong class.

16. A computer program product comprising a non-transitory machine-readable medium storing instructions that, when executed by at least one programmable processor, cause the at least one programmable processor to perform operations comprising:
training a computing model, during a training phase, using historical event data associated with fraud-related events, wherein the model learns patterns to determine whether data associated with an event provides an indication that the event is fraudulent or non-fraudulent,
events inputted to the computing model being classified as fraudulent or non-fraudulent, during an operational phase, based on event-related parameters being processed by the computing model according to the training;
continue training the computing model by iteratively adjusting parameters w and b, respectively associated with weights and biases for event-related input data;
adjusting values associated with the parameters w and b to adjust preferences given to one or more event-related parameters and to influence the computing model toward generating an outcome that is more accurate; and
optimizing the computing model consistent with an objective for making the computing model more balanced, the objective being accomplished by at least attempting to cause a reduction or minimization in penalties calculated based on determining whether the computing model wrongfully categorized the events inputted to the computing model.

17. The computer program product of claim 16, wherein a stochastic gradient descend (SGD) method is utilized to adjust the values associated with the parameters w and b.

18. The computer program product of claim 16, wherein support vector machines (SVMs) are employed to implement supervised learning models with associated learning algorithms that analyze data used for classification and regression analysis to optimize the computing model.

19. The computer program product of claim 18, wherein a set of training examples marked as belonging to fraudulent or non-fraudulent categories and the SVMs are used to train the computing model as a non-probabilistic binary linear classifier and to perform a non-linear classification using a kernel method.

20. The computer program product of claim 18, wherein the SVMs are treated as max margin problems and one or more of the following linear, polynomial or Gauss kernel methods are adopted to simplify the max margin problem calculations:
$$\begin{matrix}Linear \text{:} & K ( {x}_{i} , {x}_{j} ) = {x}_{i}^{T} {x}_{j} \\ Polynomial \text{:} & K ( {x}_{i} , {x}_{j} ) = {( {ax}_{i}^{T} {x}_{j} + b )}^{d} \\ Gauss \text{:} & K ( {x}_{i} , {x}_{j} ) = {e}^{- \frac{{‖ {x}_{i} - {x}_{j} ‖}^{2}}{2 {σ}^{2}}}\end{matrix}$$
